(19) United States
(12) Patent Application Publication
(10) Pub. No.: US 2012/0279401 A1
(43) Pub. Date: Nov. 8, 2012

(54) Egg Scrambler for Preparing Scrambled Eggs

(75) Inventor: Karl Heinze, West Chicago, IL (US)

(73) Assignee: PRINCE CASTLE LLC, Carol Stream, IL (US)

(21) Appl. No.: 13/102,267

(22) Filed: May 6, 2011

(51) Int. Cl. A47J 43/20

(52) U.S. Cl. 99/440

(57) ABSTRACT

An egg scrambler formed as a tube of a relatively soft, elastomeric material such as silicon rubber can be scraped over a thin Teflon® sheet to scramble liquid egg, without leaking uncooked egg and without tearing or abrading the sheet. A silicone rubber having a Shore type-A hardness between 40 and 85 is usable but is preferably between about 75 and 85 and with an optimal hardness of about 80.

### BACKGROUND

Most restaurants and high volume institutional food service operations scramble eggs on a flat, hot grill surface. Large quantities of an egg mix may be prepared in advance from which smaller portions are used during service. This ensures that orders can be filled with scrambled eggs that are fresh off the grill rather than batches that are held for extended periods of time.

A recent advance in food preparation in restaurants and high volume institutional food service operations is the use of a very thin Teflon® sheet laid over a grill and on which foods can be prepared. At the end of the day, or when the menu changes, the Teflon® sheet is removed and replaced with a new sheet. The use of a Teflon® sheet thus simplifies cleanup.

Using a thin sheet of Teflon® as a cooking surface is problematic when foods prepared on the Teflon® sheet are scraped in the course of food preparation. Scrambling eggs for example requires the surface on which the eggs are cooked to be scraped. Scraping the Teflon® sheets laid over a grill will damage the sheet. An apparatus for scrambling eggs which reduces or eliminates the tendency of a prior art egg scrambler to tear or abrade a thin sheet of material would be an improvement over the prior art.

### BRIEF DESCRIPTION OF THE DRAWINGS

FIG. 1 is a perspective view of an egg scrambling ring;

FIG. 2 is a side elevation view of the egg scrambling ring on a Teflon® sheet cooking surface;

FIG. 3 is a top view of the egg scrambling ring;

FIG. 4 is a cross-sectional view of a side wall of the egg scrambling ring taken through section lines 3-3;

FIG. 5 is an isolated view of a flange that comprises the end of the egg scrambling ring depicted in FIG. 1 and FIG. 2;

FIG. 6 is an isolated view of an alternate embodiment of a flange; and

FIG. 7 is a side view of an alternate embodiment of the egg scrambling ring.

### DETAILED DESCRIPTION

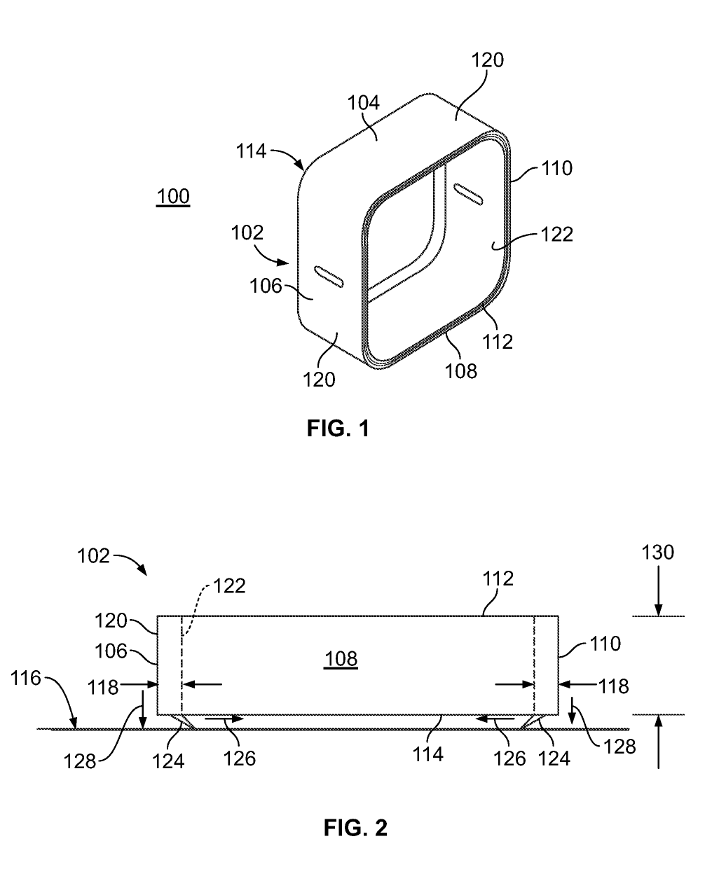

FIG. 1 is a perspective view of an egg scrambler for preparing scrambled eggs 100. The egg scrambler 100 is comprised of a continuous, square tube 102 having four side walls 104, 106, 108 and 110 and opposing first and second ends 112 and 114. The egg scrambler 100 is depicted in FIG. 1 as resting on one side 108. One of the ends 112 is denominated as a first or top end because it faces away from a cooking surface. The opposite end 114 is denominated as the second or bottom end. When the egg scrambler is used, the bottom end abuts a cooking surface, such as a Teflon® sheet laid over a grill.

FIG. 2 is a side view of the egg scrambler 100 and is depicted in FIG. 2 as resting on a Teflon® sheet 116 that is overlaid a cooking surface. The tube 102 is formed from an elastomeric material, preferably silicone rubber. Each wall 104, 106, 108 and 110 has a thickness 118 defined by the distance separating each wall's exterior surface 120 and each wall's interior surface 122. The distance or separation between the exterior surface 120 and the interior surface 122 of a wall thus defines a wall thickness 118.

The tube 102 is molded and formed to provide a small, substantially triangular flange 124 that extends downwardly from the second or bottom surface 114. The flange 124 extends completely around the second or lower end 114 to confine an interior region or area A. The flange 124 extends radially inward, i.e., into the confined area A, as shown by the arrows identified by reference numeral 126. The flange 124 is thus considered to extend inward from the walls and their interior surfaces 122.

The tube 102 is considered as having a height 130 defined by the distance between the first end 112 and the second end 114. FIG. 2 shows that the flange 124 extends downwardly from the second or bottom end 114, i.e., toward the cooking surface 116, as represented by arrows identified by reference numeral 128. The flange 124 is thus considered as extending the height 130 of the tube 102 beyond the second or lower surface 114.

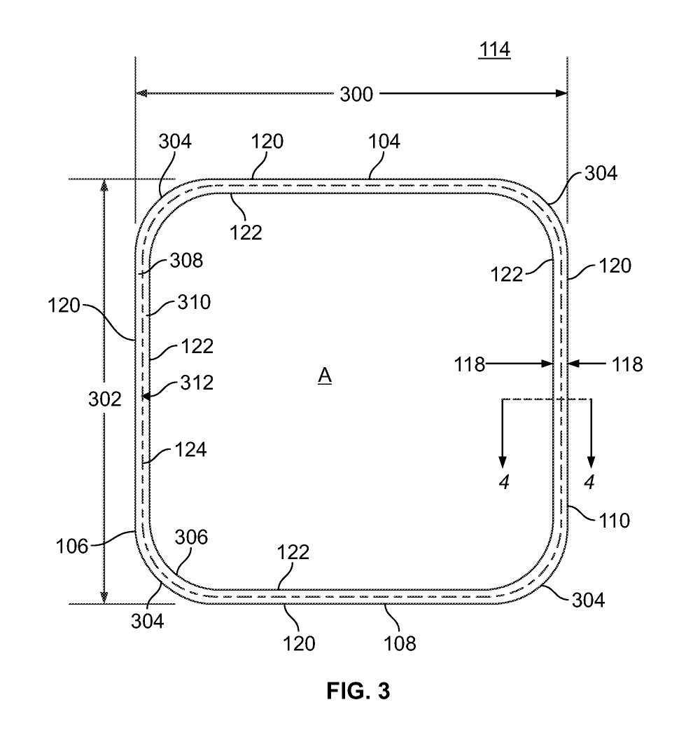

FIG. 3 is a top view of the bottom or second end 114 of the tube 102. FIG. 3 shows that the tube 102 has a width 300 and a length 302 and encircles an area A in which eggs are scrambled. The length 302 and the width 300 are substantially equal. Corners 304 are formed with a radius 306 due to the fact that the material is relatively soft and molded. In one embodiment the silicone rubber, i.e., elastomeric material, from which the ring 102 was molded had Shore type-A durometer hardness between about 40 and 95. In another embodiment the elastomeric material has a Shore type-A hardness between 75 and 85. Testing showed that when the ring 102 is used on a thin Teflon® sheet, a Shore type-A hardness value about 80 reduced or eliminated liquid egg leakage without tearing or abrading a Teflon® sheet.

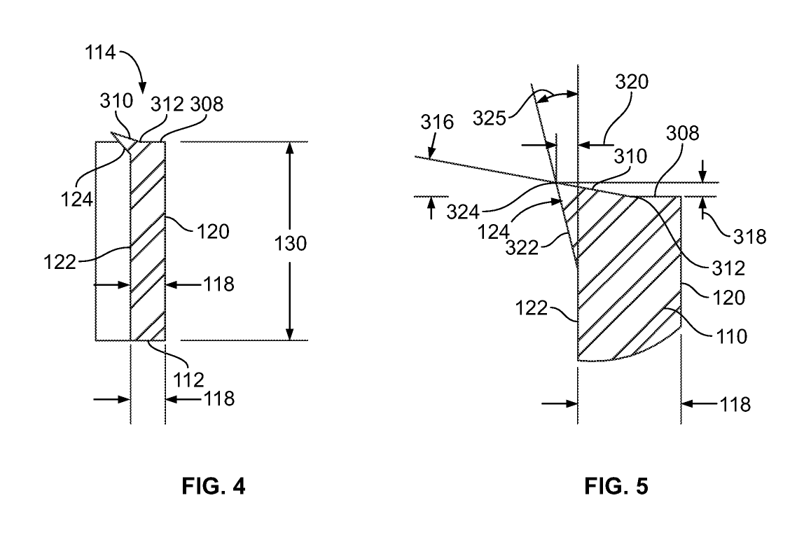

FIG. 4 is a cross-sectional view of one side wall 110 taken through section lines 4-4 and with the second or bottom end 114 facing “upwardly.” The flange 124 is thus shown extending upwardly from the bottom or second end 114 of the side wall 110.

The flange 124 can be seen in FIG. 4 as actually being comprised of two parts or portions. A first substantially planar portion 308 is substantially orthogonal to the sidewalls (104, 106, 108 and 110) and extends horizontally from the outside surface 120 of a sidewall (104, 106, 108 and 110) inwardly, i.e., toward the enclosed area A, to an intersection point 312 located approximately halfway between the inside surface 122 and the outside surface 120 of the sidewalls. A second inclined portion 310 meets the first portion at the intersection point 312 and extends upwardly or away from the first planar portion 308. An obtuse angle is one that is greater than ninety degrees and less than one-hundred eighty degrees. The planar portion 308 and the inclined portion 310 form an obtuse angle.

FIG. 4 depicts only a cross-section taken through section 4-4 of one wall 110. Since the planar portion 308 and the inclined portion 310 are formed into the second or bottom end 114 to extend completely around the tube 102, the inclined portion 310 and the planar portion 308 can be considered as lying in corresponding horizontal and inclined geometric planes. Those two surfaces 308 and 310 thus form an obtuse dihedral angle.

FIG. 5 is an isolated view of the flange depicted in FIG. 4. It can be seen as being formed into one end 114 of the tube 102, and extending inwardly and upwardly from the planar portion 308. The planar portion 308 can be seen as extending approximately halfway between the inside surface 120 of the side wall 110 to the intersection 312 with the incline portion 310.

The inclined portion 310 is shown in FIG. 5 as being inclined at a small angle 316 relative to the planar portion 308. Testing revealed that the optimum value for the inclination angle 316 was about 9.2 degrees. The inclined portion 310 thus extends the height 130 of the side wall at the inside surface 122 by a small distance above the planar portion 308. In a preferred embodiment, the extended distance above the planar portion 308 was approximately 0.028 inches above the planar portion 308.

The flange 124 also extends the inside surface 122 into the enclosed area A, i.e., laterally, by a distance identified by reference numeral 320. In a preferred embodiment, the lateral or inward extension was about 0.056 inches.

The flange 124 is also comprised of a return surface 322, which extends from the apex 324 of the flange back to the side wall 122. In a preferred embodiment, the return surface 322 defined a plane inclined inwardly, i.e., relative to the inside surface 122 by an angle of about 15 degrees. The return surface 322 and the inclined portion 312 imbue the flange 124 with a cross-sectional shape that is reminiscent of a triangle, the third side of which extends through the sidewall. More particularly, the cross section of the flange 124 is reminiscent of an acute triangle. By changing the length of the inclined portion, the length of the return surface 322 and the inclination angles of both, it is possible to provide a flange 124 with other cross-sectional shapes, i.e., shapes that are reminiscent of equilateral, obtuse, scalene, isosceles and right triangles.

The tube 102 is made from a relatively soft, silicon rubber. The shape and projection of the flange 124 thus provides a relatively thin edge or surface on which the weight of the tube 102 will rest and thus deform the flange 124 over small irregularities in a surface on which the tube 102 is placed. More importantly, tests showed that when the tube 102 is made of a soft material, the compliant projection provided by the flange 124 can be scraped over a thin Teflon® sheet without tearing or abrading the sheet 116 and without leaking uncooked, liquid egg.

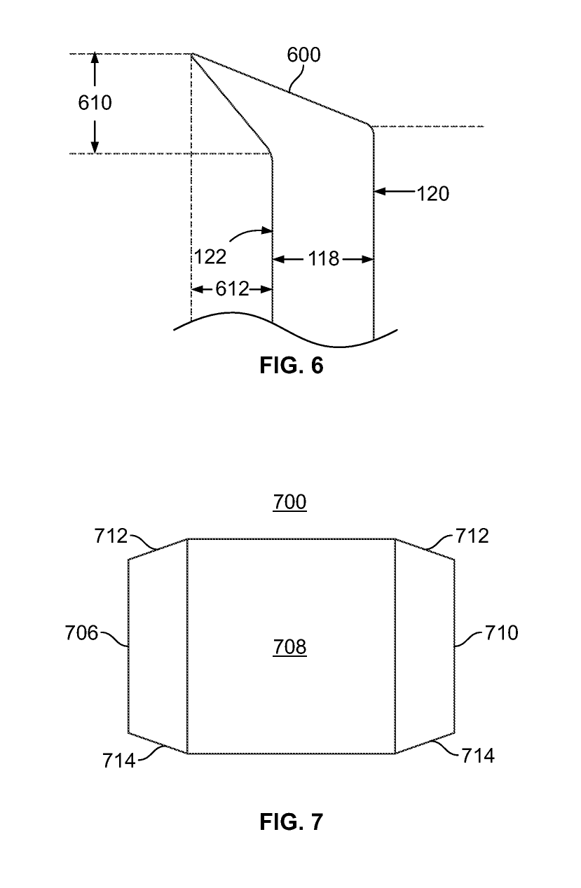

FIG. 6 shows an alternate embodiment of a flange 600 usable with the tube 102 depicted in FIGS. 1-5, i.e., constructed of the same material. In FIG. 6, the flange 600 is defined by an inclined part 310 that extends from the exterior surface 120. The inclined flange 600 extends the length of the tube by a distance identified by reference numeral 610. It also extends the inside surface 122 by a distance identified by reference numeral 612. The embodiment of the tube that is shown in FIG. 6 is considered to have at least one end that is completely inclined relative to horizontal.

FIG. 7 depicts a cross-sectional diagram of another embodiment of an egg scrambler 700 constructed of the same material but wherein both ends 712 and 714 are provided with wholly inclined surfaces. In this embodiment, the side walls 704, 706, 708 and 710 have first and second ends 712 and 714 that are both beveled. The cross-sectional shape of the side wall is thus trapezoidal. The trapezoidal-shaped sidewalls give the tube shown in FIG. 7 the ability to be reversible, i.e., each end will scrape liquid egg over a Teflon® sheet without tearing the sheet and without leaking the liquid egg from inside the tube.

While the tube depicted in the figures above has a square or rectangular cross-section, and is thus non-circular, alternate embodiments include a tube having a cross-section that is circular, triangular, elliptical or other shape.

The foregoing description is for purposes of illustration only. The true scope of the invention is set forth in the appurtenant claims.

What is claimed is:

1. An egg scrambler comprised of:
a tube formed from an elastomeric material, the tube having an interior surface, an exterior surface, a wall thickness and first and second open and opposing ends.

2. The egg scrambler of claim 1, wherein at least one end is comprised of a flange extending around the interior surface of the tube.

3. The egg scrambler of claim 2, wherein the flange extends radially inward from the interior surface and extends beyond the first end in a direction substantially parallel to the wall.

4. The egg scrambler of claim 3, wherein the flange has a cross-sectional shape that is substantially triangular.

5. The egg scrambler of claim 4, wherein the substantially triangular shape is reminiscent of an acute triangle.

6. The egg scrambler of claim 1, wherein the elastomeric material has a Shore type-A durometer hardness between about 40 and 95.

7. The egg scrambler of claim 1, wherein the elastomeric material has a Shore type-A durometer hardness between about 75 and 85.

8. The egg scrambler of claim 1, wherein the tube has a non-circular cross-sectional shape.

9. An egg scrambler comprised of:
a tube formed from an elastomeric material, the tube having an interior surface, an exterior surface, a wall thickness and first and second open and opposing ends and a length between the first and second ends, at least one of the first and second ends having a substantially planar portion and an inclined portion, the substantially planar portion extending from the exterior surface inwardly and intersecting the planar portion, the planar portion and the inclined portion forming an obtuse dihedral angle.

10. The egg scrambler of claim 8, wherein the inclined portion extends away from the planar portion to extend the length of the tube at the interior surface.

11. The egg scrambler of claim 8, wherein the inclined portion has a length such that the inclined portion extends inwardly from the interior surface.

12. The egg scrambler of claim 8, wherein the elastomeric material has a Shore type-A durometer hardness between about 40 and 95.

13. The egg scrambler of claim 8, wherein the elastomeric material has a Shore type-A durometer hardness between about 75 and 85.

14. The egg scrambler of claim 8, wherein the tube has a non-circular cross-sectional shape.

15. An egg scrambler comprised of:
a tube formed from an elastomeric material, the tube having an interior surface, an exterior surface, a wall thickness and first and second open and opposing ends and a length between the first and second ends, at least one of the first and second ends being inclined.

16. The egg scrambler of claim 13, wherein at least one of the first and second ends is configured to extend the interior surface beyond the exterior surface of the corresponding end.

17. The egg scrambler of claim 14, wherein the at least one inclined end defines an edge inside the interior surface, the tube being additionally comprised of a return surface extending between the circular edge and the interior surface of the tube.

18. The egg scrambler of claim 13, wherein both the first and second ends are inclined such that the wall has a cross-sectional shape reminiscent of a trapezoid.

19. The egg scrambler of claim 1, wherein the tube has a non-circular cross-sectional shape.

20. The egg scrambler of claim 8, wherein the elastomeric material has a Shore type-A durometer hardness between about 40 and 95.
